(19) United States
(12) Patent Application Publication
(10) Pub. No.: US 2019/0007548 A1
(43) Pub. Date: Jan. 3, 2019

(54) SYSTEMS AND METHODS FOR DISCRETE LOCATION-BASED FUNCTIONALITY

(71) Applicant: The Travelers Indemnity Company, Hartford, CT (US)

(72) Inventors: Jason W. Sit, Glastonbury, CT (US); Christopher J. Bednarzyk, Simsbury, CT (US); Michael G. Vece, Clinton, CT (US); Christopher W. Luckenbach, Suffield, CT (US)

(21) Appl. No.: 15/642,667

(22) Filed: Jul. 6, 2017

Related U.S. Application Data
(60) Provisional application No. 62/525,738, filed on Jun. 28, 2017.

(51) Int. Cl. H04M 1/725; H04W 4/00; H04W 4/02; H04W 4/04

(52) U.S. Cl. CPC H04M 1/72572; H04W 4/043; H04W 4/023; H04W 4/008

(57) ABSTRACT

Systems and methods for delivering discrete location-based information and functionality, such as floor-specific directions within a building and causing automatic activation of hyper-local devices to guide a user to a desired destination.

### CROSS-REFERENCE TO RELATED APPLICATIONS

This application claims benefit and priority under 35 U.S.C. § 119(e) to U.S. Provisional Application No. 62/525,738, filed on Jun. 28, 2017 and titled “SYSTEMS AND METHODS FOR DISCRETE LOCATION-BASED FUNCTIONALITY”, which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present disclosure relates generally to identifying and providing location-dependent information and, more specifically, to a system and method for location contextual awareness, including a wireless system for delivering location-dependent information to a portable computing device.

The well-known Global Positioning System (GPS) employs a constellation of at least twenty-four (24) radio frequency transmitting satellites to provide accurate geolocation and time information to any suitable GPS radio receiver anywhere in the world. Although initially created for military purposes, GPS has proven to be a key enabler of a surprisingly wide variety of non-military, location-based services. For example, GPS is used for everything from providing driving directions to aligning amateur telescopes to site-specific crop management in agriculture. In particular, modern mobile telephony has come to rely on GPS for clock synchronization, call handoff, and device position detection for commercial and emergency services.

While the wide-ranging utility of GPS is readily apparent, unfortunately, GPS does have a number of limitations. Some of these limitations were originally and intentionally built into GPS, while others are inherent. For example, because of the possible military applications, GPS previously used a dithering algorithm to reduce accuracy by unpredictably adjusting satellite clock frequency. Military GPS receivers were capable of far greater accuracy than civilian GPS receivers because they contained an anti-dithering algorithm. However, the remarkable utility of civilian software applications relying on accurate location information caused the U.S. government to drop dithering regardless of any additional security risk.

Currently, it is the inherent limitations of using GPS radio signals for position determination that give rise to many of the most difficult problems associated with GPS. GPS requires comparison of at least four (4) radio frequency signals from four separate satellites traveling along four (4) separate orbits to provide an accurate location determination. Radio frequency signals are subject to degradation by anything in the path of the signals between the satellite transmitters orbiting Earth in space and a GPS receiver on or near the Earth's surface. Common examples of signal-degrading objects include buildings, bridges, and trees. While any intervening substance can degrade radio signals to some degree, including those associated with inclement weather, the problem of radio frequency degradation is particularly acute in enclosed environments where the satellite signals must be detected after having passed through corresponding structural materials. Structural materials often include large metal components, such as steel in particular, and other materials, that reduce radio signal strength enough to make GPS inconsistent, and often impractical, in many enclosed environments. While some GPS signals may reach a GPS receiver inside an enclosed environment, receipt of less than four (4) signals means positional accuracy is substantially or completely lost. Because GPS is not sufficiently reliable in many such environments, including enclosed environments, its application to location-based services in those environments is correspondingly reduced or eliminated. It would be desirable to replace, mitigate, and/or overcome at least some of the limitations associated with GPS in environments with significant radio signal degradation.

### SUMMARY

The present disclosure describes embodiments of systems and methods for location contextual awareness including a wireless system for delivering location-dependent information to a portable computing device. The systems and methods are particularly advantageous by providing location-dependent information to a portable computing device in places where GPS signals do not consistently reach, such as indoor environments and environments having significant GPS signal obstructions, such as those near buildings, bridges, and trees.

In some embodiments, a wireless system for delivering location-dependent information to a portable computing device includes at least one wireless transmitter adapted to transmit a unique transmitter identifier and a registry linking the unique transmitter identifier to a location identifier, the registry having memory for storing the transmitter identifier and the location identifier. In some embodiments, the wireless system includes a software application executing on the portable computing device, the software application adapted to automatically receive the transmitter identifier from the at least one wireless transmitter, access the registry memory using the transmitter identifier, receive the location identifier from the registry, and access the location-dependent information using the location identifier, the software application having a Graphical User Interface (GUI) displaying at least one user-selectable object for selectively displaying the location-dependent information.

In some embodiments, a method for delivering location-dependent information to a portable computing device includes transmitting a unique transmitter identifier from at least one wireless transmitter, linking the unique transmitter identifier to a location identifier with a registry, the registry having memory for storing the transmitter identifier and the location identifier, and automatically receiving the transmitter identifier from the at least one wireless transmitter. In some embodiments, the method includes automatically accessing the registry memory using the transmitter identifier, automatically receiving the location identifier from the registry, and displaying a GUI having at least one user-selectable object for selectively displaying the location-dependent information. In some embodiments, the method includes automatically accessing the location-dependent information using the location identifier in response to selection of a user-selectable object and displaying the location-dependent information.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1 is a block diagram of a system according to some embodiments;

FIG. 2 is a mixed block and perspective diagram of a system according to some embodiments;

FIG. 3 is a block diagram of an example data storage structure according to some embodiments;

FIG. 4 is a systemic flow diagram of a method according to some embodiments;

FIG. 5A, FIG. 5B, and FIG. 5C are diagrams of a system providing example interfaces according to some embodiments;

FIG. 6 is a block diagram of an apparatus according to some embodiments; and

FIG. 7A, FIG. 7B, FIG. 7C, FIG. 7D, and FIG. 7E are perspective diagrams of exemplary data storage devices according to some embodiments.

### DETAILED DESCRIPTION

The following description and drawings are illustrative and are not to be construed as limiting. Numerous specific details are described to provide a thorough understanding of the disclosure. However, in certain instances, well known or conventional details are not described in order to avoid obscuring the description.

Reference in this specification to “one embodiment,” “an embodiment,” “some embodiments,” or the like, means that a particular feature, structure, characteristic, advantage, or benefit described in connection with the embodiment is included in at least one disclosed embodiment, but may not be exhibited by other embodiments. The appearances of the phrase “in one embodiment” in various places in the specification are not necessarily all referring to the same embodiment, nor are separate or alternative embodiments mutually exclusive of other embodiments. Similarly, various requirements are described which may be requirements for some embodiments but not for other embodiments. The specification and drawings are to be regarded in an illustrative sense rather than a restrictive sense. Various modifications may be made thereto without departing from the scope as set forth in the claims.

Embodiments described herein are descriptive of systems, apparatus, methods, interfaces, and articles of manufacture for discrete location-based functionality. A plurality of short-range transmitters may be utilized in an indoor and/or satellite signal-obstructed environment, for example, to provide discrete (e.g., short-range, hyper-local) location-based information such as maps, directions, and dynamic actuation functionality. According to some embodiments, a plurality of low-power (e.g., one volt (1 V) to four volts (4 V)) and/or short-range (e.g., one meter (1 m) to thirty meters (30 m)) Radio Frequency (RF) and/or other short-range wireless transmission and/or broadcast (e.g., in accordance with the Bluetooth® Low-Energy (BLE) Core Version 5.0 Specification published Dec. 6, 2016 by Bluetooth® IG, Inc. of Kirkland, Wash.) devices may be utilized to (i) identify a location of a mobile device of a user within a building and/or within a particular portion of a building, (ii) identify a desired or target destination of the user within the building, (iii) provide a building and/or building floor-specific map, (iv) provide on-floor, hyper-local directions and/or navigation instructions, and/or (v) actuate one or more physical devices to direct and/or manage movement and/or access of the user (and/or others).

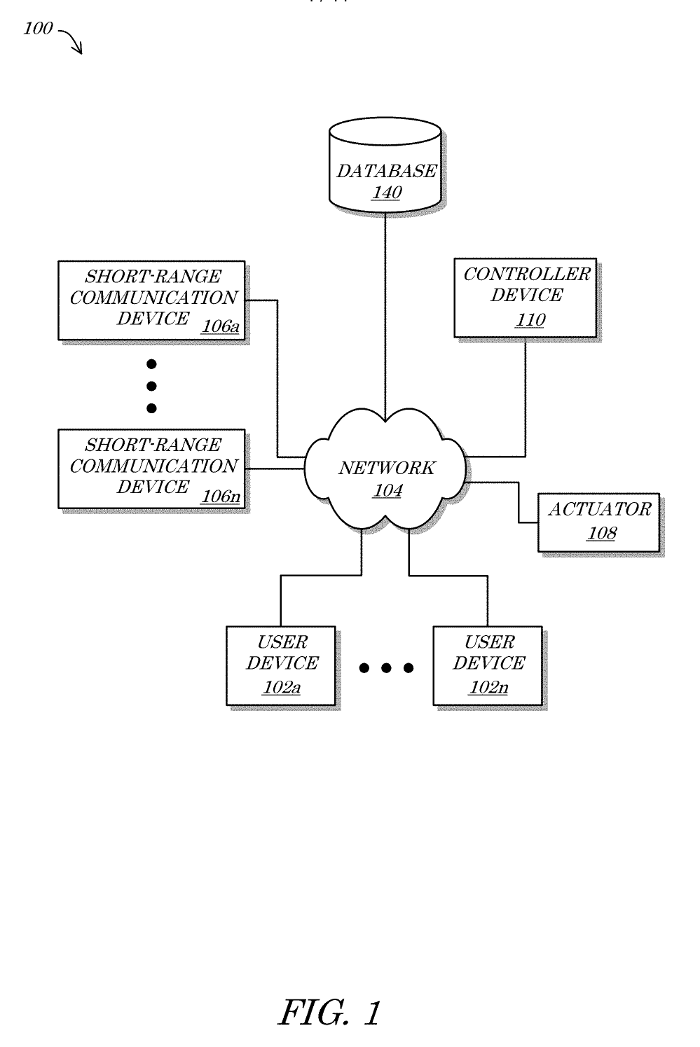

Referring first to FIG. 1, a block diagram of a system 100 according to some embodiments is shown. In some embodiments, the system 100 may comprise a plurality of user devices 102a-n, a network 104, a plurality of short-range communication devices 106a-n, an actuator 108, a controller device 110, and/or a database 140. As depicted in FIG. 1, any or all of the devices 102a-n, 106a-n, 108, 110, 140 (or any combinations thereof) may be in communication via the network 104. In some embodiments, the system 100 may be utilized to provide “discrete” location-based functionality. One or more of the short-range communication devices 106a-n may, for example, interface with one or more of the user devices 102a-n and/or the controller device 110 to provide hyper-local or “discrete” (i.e., sub-one hundred meter (<100 m) in general, and in some embodiments sub-thirty meter (<30 m)) in-structure or on-floor (i.e., on a specific floor of a building) directions and/or location-based contextual information, instructions, and/or device actuation commands.

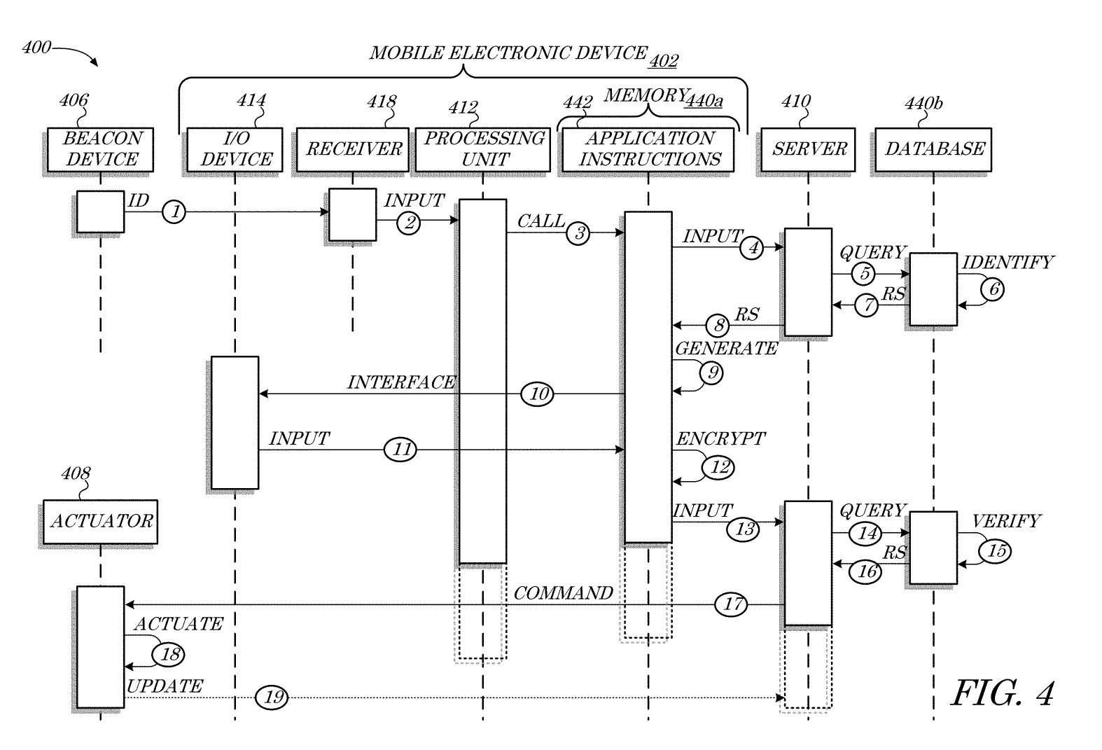

Fewer or more components 102a-n, 104, 106a-n, 108, 110, 140 and/or various configurations of the depicted components 102a-n, 104, 106a-n, 108, 110, 140 may be included in the system 100 without deviating from the scope of embodiments described herein. In some embodiments, the components 102a-n, 104, 106a-n, 108, 110, 140 may be similar in configuration and/or functionality to similarly named and/or numbered components as described herein. In some embodiments, the system 100 (and/or portion thereof) may comprise a discrete/hyper-local navigational program, system, and/or platform programmed and/or otherwise configured to execute, conduct, and/or facilitate the systemic method 400 of FIG. 4 herein, and/or portions thereof.

The user devices 102a-n, in some embodiments, may comprise any types or configurations of computing, mobile electronic, network, user, and/or communication devices that are or become known or practicable. The user devices 102a-n may, for example, comprise one or more tablet computers such as an iPad® manufactured by Apple®, Inc. of Cupertino, Calif., and/or cellular and/or wireless telephones or “smart” phones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as an employee or visitor to a particular building. According to some embodiments, the user devices 102a-n may communicate with the controller device 110 via the network 104, such as to provide unique location-indicative identifiers to trigger a provision of hyper-local functionality, as described herein. According to some embodiments, the user devices 102a-n may store and/or execute specially programmed instructions (such as a mobile device application) to operate in accordance with embodiments described herein. The user devices 102a-n may, for example, execute one or more mobile device programs that listen for a broadcast location-indicative identifier from a short-range communication device 106a-n, transmit the location-indicative identifier to the controller device 110, receive discrete location-based information from the controller device 110 in response, and utilize the discrete location-based information to generate a GUI displaying hyper-local location information such as maps, directions, etc.

In some embodiments, the user devices 102a-n may interface with the controller device 110 to effectuate communications (direct or indirect) with one or more other user devices 102a-n (such communication not explicitly shown in FIG. 1), such as may be operated by other users. In some embodiments, the user devices 102a-n may interface with the controller device 110 to effectuate communications (direct or indirect) with one or more of the short-range communication devices 106a-n (such communication also not explicitly shown in FIG. 1). In some embodiments, the short-range communication devices 106a-n may transmit and/or broadcast location-indicative identifiers that are received by the user devices 102a-n in the case that the user devices 102a-n come within a signal proximity of the short-range communication devices 106a-n. In some embodiments, such location-indicative identifiers may be provided to the controller device 110 to retrieve discrete location-based data stored in association with the location-indicative identifiers in a remote database (e.g., the database 140) and/or to trigger an activation of the actuator 108.

The network 104 may, according to some embodiments, comprise a Local Area Network (LAN; wireless and/or wired), cellular telephone, Bluetooth® and/or Bluetooth Low Energy (BLE), Near Field Communication (NFC), and/or Radio Frequency (RF) network with communication links between the controller device 110, the user devices 102a-n, the short-range communication devices 106a-n, the actuator 108, and/or the database 140. In some embodiments, the network 104 may comprise direct communications links between any or all of the components 102a-n, 106a-n, 108, 110, 140 of the system 100. The user devices 102a-n may, for example, be directly interfaced or connected to one or more of the controller device 110 and/or the short-range communication devices 106a-n via one or more wires, cables, wireless links, and/or other network components, such network components (e.g., communication links) comprising portions of the network 104. In some embodiments, the network 104 may comprise one or many other links or network components other than those depicted in FIG. 1. The user devices 102a-n may, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106a-n, 108, 110, 140 of the system 100. The network 104 may comprise one or more cellular telephone networks with communication links between the user devices 102a-n and the controller device 110, for example, and/or may comprise a BLE, NFC, and/or “personal” network comprising wireless communications between the short-range communication devices 106a-n and the user device 102a-n, for example.

The short-range communication devices 106a-n, in some embodiments, may comprise any type or configuration of short-range wireless, low-power, passive inductive, and/or other electric or electro-mechanical devices, or any combination thereof. In some embodiments, the short-range communication devices 106a-n may comprise low-voltage wireless transmitters, such as BLE devices, designed to operate in accordance with the iBeacon™ communications protocol published by Apple®, Inc. of Cupertino, Calif. The short-range communication devices 106a-n may be configured, for example, to store and automatically and intermittently broadcast (i) a Universally Unique Identifier (UUID), (ii) a “Major” information indicator, (iii) a “Minor” information indicator, and/or (iv) a signal strength indicator.

According to some embodiments, the actuator 108 may comprise any type or configuration of electric and/or electro-mechanical device and/or device actuator that is or becomes known or practicable. As utilized in non-limiting exemplary embodiments described herein, for example, the actuator 108 may comprise an electronic-actuatable door striker or lock, an electronically-controllable and/or dimmable light bulb and/or light fixture (e.g., ballast, switch, and/or relay), an intercom, turnstile, window, window shade, elevator, dispensing device (e.g., a vending machine, food/beverage dispenser, and/or a printer), and/or electrical or communication outlet and/or device. The actuator 108 may, for example, be configured to cause a physical actuation/movement of an object in response to a receipt of an electric signal and/or command.

In some embodiments, the controller device 110 may comprise an electronic and/or computerized controller device such as a computer server communicatively coupled to interface with the user devices 102a-n (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user devices 102a-n, the short-range communication devices 106a-n, and/or the actuator 108. The controller device 110 may also or alternatively comprise a plurality of electronic processing devices located at one or more various sites and/or locations.

According to some embodiments, the controller device 110 may store and/or execute specially programmed instructions to operate in accordance with embodiments described herein. The controller device 110 may, for example, execute one or more programs that facilitate and/or cause the provision of discrete location-based information and/or functionality. According to some embodiments, the controller device 110 may comprise a computerized processing device such as a PC, laptop computer, computer server, and/or other network or electronic device to manage the provision of discrete location-based information and functionality to the user devices 102a-n.

In some embodiments, the controller device 110 and/or the user devices 102a-n may be in communication with the database 140. The database 140 may store, for example, building data, floorplan data and/or maps, location data (such as coordinates, distances, etc.), security access protocol and/or verification data, device and/or actuation data, and/or instructions that cause various devices (e.g., the controller device 110, the short-range communication devices 106a-n, the actuator 108, and/or the user devices 102a-n) to operate in accordance with embodiments described herein. In some embodiments, the database 140 may comprise any type, configuration, and/or quantity of data storage devices that are or become known or practicable. The database 140 may, for example, comprise an array of optical and/or solid-state hard drives configured to store beacon identifier, user identifier, device identifier, and/or location data provided by (and/or requested by) the user devices 102a-n and/or the controller device 110, and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the user devices 102a-n or the controller device 110 may comprise the database 140 or a portion thereof, for example, and/or one or more of the short-range communication devices 106a-n may comprise the database 140 or a portion thereof.

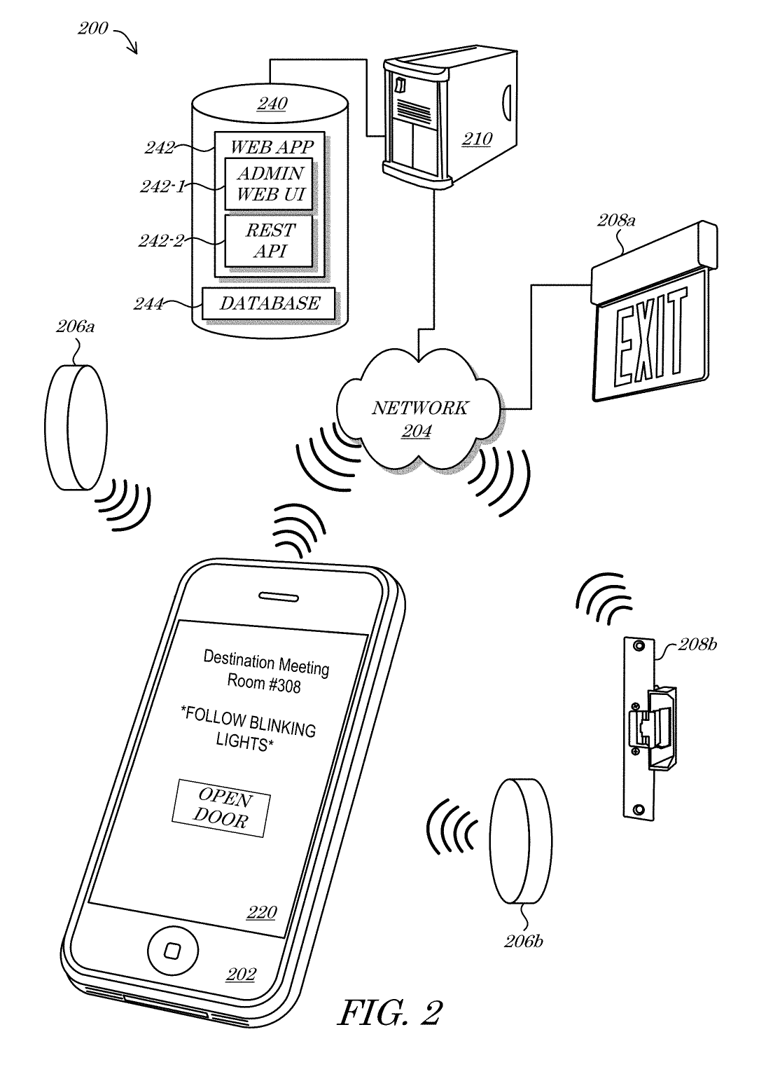

Turning to FIG. 2, a mixed block and perspective diagram of system 200, according to some embodiments, is shown. In some embodiments, the system 200 may comprise a mobile electronic device 202, a network 204, one or more wireless beacons 206a-b, one or more actuatable devices 208a-b, and/or a server 210. According to some embodiments, mobile electronic device 202 may output a GUI 220 and/or the server 210 may be in communication with a memory device 240 (e.g., storing a web application (“web app”) 242 comprising an administrator web User Interface (UI) (‘admin web UI”) 242-1 and/or a REpresentational State Transfer (REST) Application Program Interface (API) 242-2, and/or a data table 244).

Fewer or more components 202, 204, 206a-b, 208a-b, 210, 220, 240, 242, 242-1, 242-2, 244 and/or various configurations of the depicted components 202, 204, 206a-b, 208a-b, 210, 220, 240, 242, 242-1, 242-2, 244 may be included in the system 200 without deviating from the scope of embodiments described herein. In some embodiments, the components 202, 204, 206a-b, 208a-b, 210, 220, 240, 242, 242-1, 242-2, 244 may be similar in configuration and/or functionality to similarly named and/or numbered components as described herein. In some embodiments, the system 200 (and/or portion thereof) may comprise a discrete/hyper-local navigational program, system, and/or platform programmed and/or otherwise configured to execute, conduct, and/or facilitate the systemic method 400 of FIG. 4 herein, and/or portions thereof.

In some embodiments, the wireless beacons 206a-b may be associated with separate physical locations, such as distinct locations on a particular floor of a building. The wireless beacons 206a-b are not limited to any particular physical form or configuration and may be associated in part with separate physical locations by being placed and/or coupled or mounted in those locations. In some embodiments, each of the wireless beacons 206a-b is affixed to an exposed surface (not shown) at each of the separate physical locations, but the wireless beacons 206a-b are not limited to any particular method of being affixed and may simply be placed at the respective locations, including temporarily. Methods for affixing each wireless beacons 206a-b to a separate physical location include, but are not limited to, the use of Velcro®, various adhesives, clamps, screws, bolts and nuts, complementary physical surfaces employing tension and/or compression, etc.

According to some embodiments, the wireless beacons 206a-b each transmit a Unique IDentifier (UID), such as a UUID, in accordance with the BLE and/or iBeacon™ protocols referenced herein. In some embodiments, the UID may comprise a string of non-transitory, stored digital numbers designed to uniquely identify each wireless beacon 206a-b, and therefore identify the separate physical locations associated with each wireless beacon 206a-b. In some embodiments, each wireless beacon 206a-b may transmit additional data along with its UID. The additional data may provide, for example, information about each wireless beacon 206a-b, its respective physical location, and other information. In some embodiments, the other information may include an error detection code for the UID. In some embodiments, the error detection code may comprise a Hamming-based code that enables detection of up to two (2) bits in error and correction of a single bit in error. In some embodiments, the wireless beacons 206a-b each transmit a respective UID approximately every one hundred (100) milliseconds.

In some embodiments, the wireless beacons 206a-b are compatible with the iBeacon™ protocol as referenced herein. The iBeacon™ protocol is followed by devices often correspondingly labelled iBeacons™ or, more simply, “beacons”. While the term “beacon” is utilized herein to identify the wireless beacons 206a-b, the wireless beacons 206a-b of some embodiments utilize short-range communication and/or broadcast protocols other than or in addition to the iBeacon™ protocol. Typical iBeacons™ use a known Bluetooth® wireless protocol transmission standard, such as that employed in “standard” Bluetooth®, or in BLE designed to reduce power consumption and extend beacon battery life in some situations. In some embodiments, the wireless beacons 206a-b may comprise any devices capable of wirelessly transmitting the UID, such as other Bluetooth®-compatible devices, WiFi®-compatible devices, and Radio Frequency Identification (RFID)-compatible devices.

In some embodiments, the wireless beacons 206a-b are relatively small and inexpensive to better facilitate their deployment at separate physical locations, e.g., inside buildings where GPS signals do not consistently reach. In some embodiments, the wireless beacons 206a-b are placed at the entrances/exits of office buildings, as well as at locations of particular relevance within different floors of those buildings, to identify those locations. For example, in some embodiments the wireless beacons 206a-b are located within or near an entrance, an exit, an emergency exit, a classroom, a conference room, a break room, a bathroom, a meeting area, an auditorium, a local employee's office, a muster point for evacuation, a food/beverage service location, and other hyper-local locations of interest. In some embodiments, the wireless beacons 206a-b are placed in a grid pattern in each floor. In some embodiments, a combination of locating the wireless beacons 206a-b at locations of particular relevance and in a grid pattern within floors of those buildings to identify those locations may be utilized.

In some embodiments, the wireless beacons 206a-b each transmit their UID and/or other information to the mobile electronic device 202, located in proximity thereto. In some embodiments, the mobile electronic device 202 may comprise a smart mobile phone, such as the iPhone® 4s or a later generation iPhone®, running iOS 7 or a later generation of iOS, supporting Location Services. The iPhone® and iOS are produced by Apple Inc., however, the present invention is not limited to any particular portable computing device or smart mobile phone. For example, the mobile electronic device 202 may take the form of a laptop computer, a handheld computer, a palm-size computer, a pocket computer, a palmtop computer, a Personal Digital Assistant (PDA), a tablet computer, an electronic organizer, a mobile phone, a portable/mobile phone, a feature phone, a smartphone, a phablet, a portable/mobile data terminal, an iPhone®, an iPad®, an iPod®, an Apple® Watch (or other “smart” watch), and other portable form-factor devices by any vendor containing at least one Central Processing Unit (CPU) and a wireless communication device. In some embodiments, the mobile electronic device 202 contains a visual display for displaying information to the user, e.g., via the GUI 220.

According to some embodiments, the mobile electronic device 202 runs (i.e., executes) a mobile device software application (“app”) that causes the generation and/or output of the GUI 220. In some embodiments, the app works with Location Services supported by an iOS operating system executing on the mobile electronic device 202. If at least one wireless beacon 206a-b is in range (i.e., signal transmission range dictated by the signal output strength of the particular wireless beacon 206a-b and as propagated throughout the respective surrounding environment), the UID transmitted by that particular wireless beacon 206a-b is received by the mobile electronic device 202 (e.g., a receiver thereof; not explicitly shown in FIG. 2) and utilized as input for the app. The app may include, comprise, and/or cause the generation of the GUI 220, which may be utilized, for example, for transmitting and/or exchanging data through and/or via the network 204 (e.g., the Internet). In some embodiments, once the app receives the UID from the wireless beacon 206a-b, the app in turn transmits the UID as data through an interface for exchanging data and through the network 204. The network 204 routes the data out through an interface for exchanging data to the server 210. According to some embodiments, the app includes specially-programmed software code that includes one or more address identifiers such as Universal Resource Locator (URL) addresses, Internet Protocol (IP) address, etc., that point to and/or reference the server 210.

In some embodiments, the server 210 may comprise a “cloud app engine” such as a Google® Cloud App Engine executing on a Google® Cloud Platform produced by Google, Inc., a subsidiary of Alphabet Inc., 1600 Amphitheatre Parkway, Mountain View, Calif. 94043. The server 210 may comprise, for example, the web app 242 that supports execution of a Java™ web app. The web app 242 may itself support execution of the admin web UI 242-1 and/or the REST API 242-2. The REST API 242-2 may, in some embodiments, receive the UID via the network 204 and transmit the UID as part of data passed through an interface for exchanging data to the database 240. In some embodiments, the database 240 may comprise a Google® Data Store service available from Google®, Inc. and/or an Amazon® Simple Storage Service (“S3”) available from Amazon® Web Services, Inc. of Seattle, Wash.

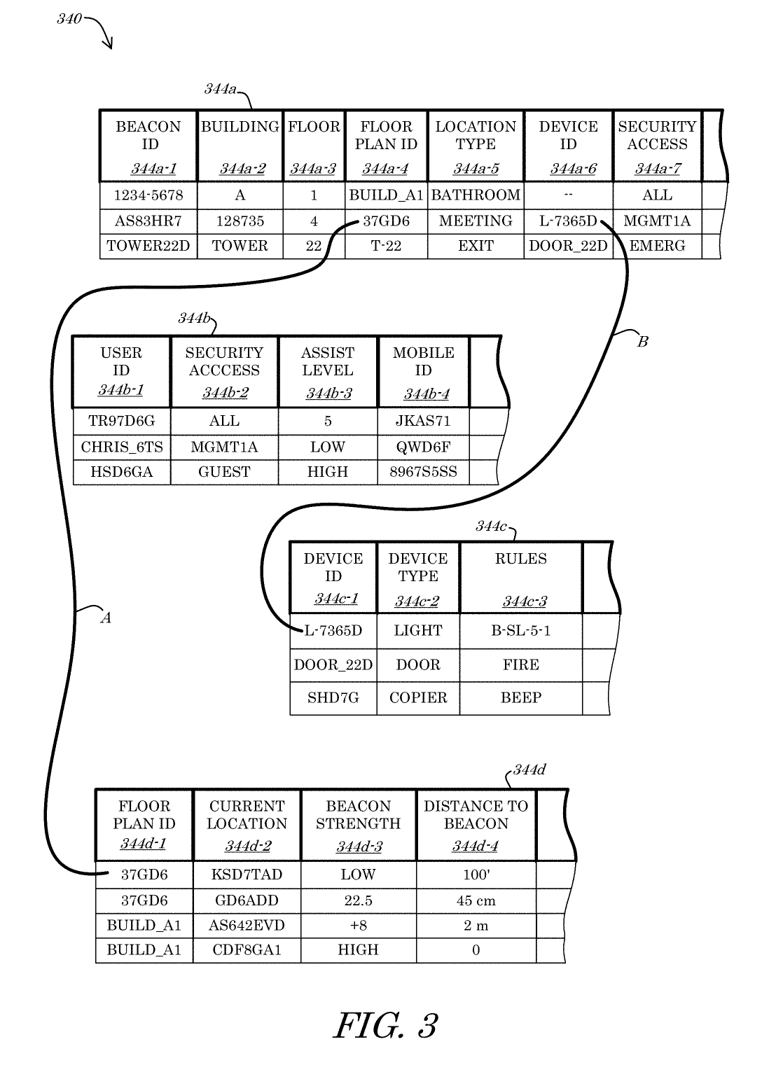

In some embodiments, the database 240 supports a web service location registry for linking each UID with a location identifier that identifies a separate physical location. In some embodiments, the registry (e.g., the example data storage structure 340 of FIG. 3 herein) contains a database, table, and/or file relating each UID with its respective location identifier. In some embodiments, the registry contains a lookup table relating each UID with its location identifier. In some embodiments, the separate physical location identified in the location identifier is represented by grid coordinates of a map of a floor and building where the wireless beacon 206a-b is placed. The location identifier is not limited to any particular format for identifying location and any compatible coordinate system may be utilized. The database 240 may, in some embodiments, pass the location identifier from the registry through the interface for exchanging data to the REST API 242-2. In turn, the REST API 242-2 may pass the location identifier through the interface for exchanging data, via the network 204, and through the interface for exchanging data to the mobile electronic device 202 (and/or app thereof).

The app may then, for example, utilize the location identifier to access discrete location-dependent information stored locally on the mobile electronic device 202 and/or stored in the database 240. The discrete location-dependent information may include, for example, a map selected from a library of maps and corresponding locations of at least one of an entrance, an exit, an emergency exit, a classroom, a conference room, a break room, a bathroom, a meeting area, an auditorium, a local employee directory, a cafeteria menu, a muster point for evacuation, a bulletin with local information, and other local locations and hyper-local data of interest. The app may store the discrete location-dependent information and display at least a portion of such information via the GUI 220 on the display of the mobile electronic device 202.

In some embodiments, the app may identify and/or compute an approximate location of the mobile electronic device 202 (and presumably a user (not shown) in possession of the mobile electronic device 202 as well). The app may then, for example, push the approximate location to the user via the GUI 220. In some embodiments, the app may determine the approximate location of the mobile electronic device 202 through triangulation of two (2) or more wireless beacons 206a-b. In some embodiments, the app may determine the approximate location of the mobile electronic device 202 by calculating a distance from each wireless beacon 206a-b based on a measured signal strength thereof. In some embodiments, for example, the app has access to signal strength data indicating the signal strength from the wireless beacon 206a-b at its source. The app may utilize the signal strength data at the source, i.e., absolute signal strength, in combination with measured signal strength to calculate the distance based on the mathematical principle (formula) that a strength (e.g., magnitude) of a wireless signal decreases with the inverse square of the distance from the source. In some embodiments, the app does not calculate the distance, but accesses a lookup table that contains a set of measured signal strengths and a corresponding set of approximate distances. In some embodiments, the approximate distances in the lookup table are calculated based on the principle that the strength of the wireless signal decreases with the inverse square of the distance from the source. In some embodiments, the approximate distances are determined empirically through measuring both signal strength and distance during initial setup.

According to some embodiments, the app generates the GUI 220 that displays at least one user-selectable object for selectively displaying the location-dependent information. As depicted for exemplary purposes in FIG. 2, for example, the GUI 220 may output an indication that the desired or target destination is “Meeting Room #308” and an instruction that the user should “Follow Blinking Lights” toward the destination. The server 210 may cause, for example, a first one of the actuatable devices 208a, such as a lighted exit sign (or other light bulb or fixture), to blink in the case that the first one of the actuatable devices 208a is identified as being disposed along a desired route for the user to take to arrive at the desired/target destination. In some embodiments, a second one of the actuatable devices 208b may comprise an automatic door latch or bolt. In the case that the desired/target location requires access through a particular secured doorway, for example, the user may activate an “open door” button via the GUI 220 to send a command signal to the second one of the actuatable devices 208b that causes the second one of the actuatable devices 208b to actuate or disengage (e.g., allowing the door to be opened). According to some embodiments, an activation signal or request from the GUI 220 may be transmitted to the server 210 and the server 210 may send a command and/or trigger signal to the second one of the actuatable devices 208b, causing activation of the second one of the actuatable devices 208b. In some embodiments, the triggering of the second one of the actuatable devices 208b may be automatic, such as an automatic trigger signal sent by the server 210 (and/or the mobile electronic device 202), based on the current location of the mobile electronic device 202/user with respect to the second one of the actuatable devices 208b.

In some embodiments, the system 200 for providing discrete location-dependent information and/or functionality is automatically set up and maintained. In some embodiments, for example, placement and activation of the wireless beacons 206a-b causes an automatic exchange of data with the app running in an administrator mode. The app may exchange data regarding the identification and physical placement of each of the wireless beacons 206a-b with the web app 242 through the REST API 242-2. The web app 242-2 may, for example, log and track changes in the number and/or location of wireless beacons 206a-b over time. In some embodiments, addition of one more wireless beacons 206a-b, elimination of one or more wireless beacons 206a-b, and/or movement or one or more wireless beacons 206a-b, are tracked by the web app 242-2.

In some embodiments, the system 200 for providing discrete location-dependent information and/or functionality is set up and maintained by an administrator (not shown). The administrator may access the server 210 directly and/or via the network 204 and may utilize an interface for exchanging data with the admin web UI 242-1 (e.g., implemented and/or supported by the web app 242). According to some embodiments, the admin web UI 242-1 enables the administrator to set up and maintain the registry (e.g., write data to the data table 244) to perform initial provisioning, correct errors, and/or respond to changed conditions over time. The admin web UI 242-1 may be utilized, for example, to write, modify, and/or delete data from the data table 244 and/or to establish, edit, and/or manage one or more relationships between stored data items and/or elements (e.g., a relation between a UUID and a particular location within a building).

Referring to FIG. 3, for example, a diagram of an example data storage structure 340 according to some embodiments is shown. In some embodiments, the data storage structure 340 may comprise a plurality of data tables, such as a beacon table 344a, a user table 344b, a device table 344c, and/or a floorplan table 344d. The data tables 344a-d may, for example, be utilized (e.g., in the systemic method 400 of FIG. 4) to store, modify, update, retrieve, and/or access various information related to beacons, employees (or other users), locations associated with beacons and/or employees, devices (e.g., actuatable devices), hyper-local navigational routes and/or routing methods, and/or security protocols and/or access verification or authentication requirements. In some embodiments, the data storage structure 340 (or a portion thereof) may comprise a wireless beacon location registry that correlates wireless beacon locations with information descriptive of the location in which any particular wireless beacon is disposed, coupled, mounted, and/or associated.

The beacon table 344a may comprise, in accordance with some embodiments, a beacon IDentifier (ID) field 344a-1, a building field 344a-2, a floor field 344a-3, a floorplan ID field 344a-4, a location type field 344a-5, a device ID field 344a-6, and/or a security access field 344a-7. Any or all of the ID fields 344a-1, 344a-4, 344a-6 may generally store any type of identifier that is or becomes desirable or practicable (e.g., a UID, a UUID, an alphanumeric identifier, and/or an encoded or encrypted identifier). As an example of how the example data structure 340 may be utilized in accordance with some embodiments, the beacon table 344a may store information relating each of a plurality of particular beacons (e.g., identified by UUID and/or UIDs and/or codes stored in the beacon ID field 344a-1) to a plurality of particular and/or discrete locations. In such a manner, for example, a beacon ID may be utilized to retrieve information descriptive of a location at which the particular identified beacon is disposed—such as which building the beacon is in (stored in the building field 344a-2), which floor of the building the beacon is on (stored in the floor field 344a-3), what map/image/navigational tool should be used for users proximate to the beacon (stored in the floorplan ID field 344a-4), a type of location at which the beacon is disposed (stored in the location type field 344a-5), an actuatable device (e.g., light, door, turnstile, elevator, etc.) at or near the location at which the beacon is disposed (stored in the device ID field 344a-6), and/or a security access level, requirement, and/or authentication required for access to (or from) the location in which the beacon is disposed (stored in the security access field 344a-7).

The user table 344b may comprise, in accordance with some embodiments, a user ID field 344b-1, a security access field 344b-2, an assist level field 344b-3, and/or a mobile ID field 344b-4. The user table 344b may store, for example, data descriptive of various attributes, identifiers, and/or characteristics associated with and/or assigned to a particular user. In some embodiments, the security access field 344b-2 may store information descriptive of a level and/or type of security access assigned to a user and/or one or more security parameters, codes, and/or identifiers that may be utilized to verify and/or authenticate a particular user. According to some embodiments, the assist level field 344b-3 may store data defining a level of assistance that a user should receive with respect to discrete location-based navigation and/or assistance. While a “guest” may warrant a high level of assistance, such as dynamically lighting hyper-local navigational paths, for example, a long-time employee may only warrant or require minimal assistance, such as occasional audible cues to locate a particular office or room. In some embodiments, the mobile ID field 344b-4 may store an identifier for one or more mobile electronic devices assigned to, owned, operated by, and/or otherwise associated with the user. The discrete location-based mobile application may only be permitted to operate or must operate in accordance with certain rules (e.g., security and/or preference settings), for example, in the case that certain devices, types of device, and/or combinations of devices and users are employed in a hyper-local informational/navigational system as described herein.

The device table 344c may comprise, in accordance with some embodiments, a device ID field 344c-1, a device type field 344c-2, and/or a rules field 344c-3. The device type field 344c-2 may store, for example, information descriptive of a type of actuatable device, e.g., disposed at a particular location and/or associated with one or more particular wireless beacons. In some embodiments, the rules field 344c-3 may store data defining one or more rules applicable to the specific actuatable device. Such information may include, for example, a rule regarding which users may utilize the actuatable device (e.g., a security-based rule), a rule regarding when the actuatable device may be activated (e.g., only in emergencies, only during the day, etc.), a rule defining an action that the actuatable device will take upon receiving a command (e.g., open, close, blink, blink slowly at five (5) second intervals for one (1) second at a time, beep, illuminate to fifty-percent (50%), etc.), and/or an access code, communication protocol, command, public decryption key, etc., that may be utilized to activate a particular actuatable device.

The floorplan table 344d may comprise, in accordance with some embodiments, a floorplan ID field 344d-1, a current location field 344d-2, a beacon strength field 344d-3, and/or a distance to beacon field 344d-4. The floorplan table 344d may, for example, store data descriptive of particular floorplans, buildings, discrete locations, rooms, etc. In some embodiments, the current location field 344d-2 may store data indicative of a current location of a user and/or device operated by the user. According to some embodiments, the beacon strength field 344d-3 may store a measured strength of the wireless signal from the beacon, as sampled at the current location, and/or a reference signal strength of the beacon's signal. In some embodiments, the current location, measured signal strength, reference or baseline signal strength, and/or other stored location and/or signal information may be utilized to calculate or lookup an estimated distance between the beacon and the user/user's device, which may be stored, for example, in the distance to beacon field 344d-4.

As indicated by the example data in the data storage structure 340, a user identified by “HSD6GA” as stored in the user ID field 344b-1 may identify a signal from a beacon identified by “AS83HR7” as stored in the beacon ID field 344a-1 (e.g., utilizing a mobile electronic device identified by “8967S5SS” as stored in the mobile ID field 344b-4 and/or a mobile application executed thereon).

In some embodiments, discrete location-based information and/or functionality may be defined and/or provided by relationships established between two or more of the data tables 344a-d. As depicted in the example data storage structure 340, for example, a first relationship “A” may be established between the beacon table 344a and the floorplan table 344d. In some embodiments (e.g., as depicted in FIG. 3), the first relationship “A” may be defined by utilizing the floorplan ID field 344a-4 as a data key linking to the floorplan ID field 344d-1. According to some embodiments, the first relationship “A” may comprise any type of data relationship that is or becomes desirable, such as a one-to-many, many-to-many, or many-to-one relationship. In the case that a single location/floorplan is likely to be applicable to a plurality of beacons, the first relationship “A” may comprise a many-to-one relationship (e.g., many beacons per floor of a building).

According to some embodiments, a second relationship “B” may be established between the beacon table 344a and the device table 344c. In some embodiments (e.g., as depicted in FIG. 3), the second relationship “B” may be defined by utilizing the device ID field 344a-6 as a data key linking to the device ID field 344c-1. According to some embodiments, the second relationship “B” may comprise any type of data relationship that is or becomes desirable, such as a one-to-many, many-to-many, or many-to-one relationship. In the case that multiple actuatable devices may be associated with a single location and/or beacon, the second relationship “B” may comprise a one-to-many relationship (e.g., many devices per single beacon). In such a manner, for example, weather alerts and/or tips or actions may be provided to a user/customer for any number of locations associated with the user/customer.

Utilizing the various relationships, “A” and “B”, it may accordingly be possible to readily identify for any particular beacon and/or location, any relevant and/or applicable hyper-local information, such as building floorplans, office-to-office directions, nearest bathroom or exit directions, etc. The user “HSD6GA” from the example above, for example, may be provided with maps, directions, and/or information (e.g., food/beverage options) for the fourth (4th) floor of the building identified as “128735” based on having discovered the identification signal from the beacon identified as “AS83HR7”. In some embodiments, because the beacon/location is associated with the actuatable light identified as “L-7365D” as stored in the device ID fields 344a-6, 344c-1, the light may be actuated to assist the user in finding the way to the “meeting” room associated with the identified beacon. According to some embodiments, because the “meeting” room is associated with a security access level of “MGMT1A” (e.g., management level “1A”) but the user is merely a “GUEST”, the user may not be provided with directions, may be provided with directions but not access, may be warned regarding the conflict in security access levels, a third-party may be notified of the conflict, and/or the actuatable light may not be triggered or activated—e.g., it may be blocked from access due to the incorrect security access level.

In some embodiments, fewer or more data fields than are shown may be associated with the data tables 344a-d. Only a portion of one or more databases and/or other data stores is necessarily shown in the data storage structure 340 of FIG. 3, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein.

Referring now to FIG. 4, a systemic flow diagram of a process 400 according to some embodiments, is shown. The process 400 may, for example, be executed by various hardware and/or logical components via interactive communications, such as may involve communications between any or all of a mobile electronic device 402 (e.g., comprising a processing unit 412, an I/O device 414, and/or a receiver 418), a beacon device 406, an actuator 408, a server 410, and/or various memory devices 440a-b. In some embodiments, a first memory 440a may reside in or on the mobile electronic device 402 and/or may store mobile application instructions 442.

In some embodiments, the process 400 (e.g., for delivering location-dependent information to the mobile electronic device 402) may begin at “1” with a transmitting of a unique transmitter identifier (e.g., a UUID; and/or other information, such as signal strength information as described herein) from at least one wireless beacon device 406 to the receiver 418 (and accordingly the receipt of the identifier thereof) of the mobile electronic device 402. As described herein, each of a plurality of wireless transmitters, such as the beacon device 406, may comprise a unique transmitter identifier stored internally and available for transmission at “1”, e.g., to uniquely identify itself. In some embodiments, the receiver 418 may provide and/or forward the identifier (and/or other data received from the beacon device 406) as input to the processing unit 412 at “2”. The mobile electronic device 402 may then, for example, utilize the unique transmitter identifier (and/or other received data) to identify a location identifier within a remote registry. In some embodiments, the remote registry may reside in the database 440b. The registry may, for example, comprise memory for storing the transmitter identifier in relation to the location identifier. According to some embodiments, for example, the processing unit 412 may utilize the receipt of the beacon information to trigger a call or initiation of the application instructions 442, at “3”.

In some embodiments, the application instructions 442 may also or alternatively perform a polling loop, causing the application instructions 442 to be automatically waiting for receipt of the transmitter identifier from the beacon device 406 (and/or another wireless beacon, not shown). According to some embodiments, upon receipt of the UID and/or a trigger or call by the processing device 412, the application instructions 442 may automatically access the registry memory (e.g., the database 440b) using the transmitter identifier to retrieve discrete location-based information and/or functionality associated with the beacon device 406 and/or a specific discrete location thereof. The application instructions 442 may, for example, send the transmitter identifier (and/or other beacon data) as input to the server 410, at “4”. The transmitting at “4” may, in some embodiments, result from an automatic activation of a hard-coded network address or remote identifier of the server 410 embedded within and/or accessible to the application instructions 442. In some embodiments, the server 410 may utilize the information received at “4” to structure and/or initiate a query to the database 440b, at “5”.

According to some embodiments, at “6” the database 440b (and/or a controlling device thereof, such as a database administration and/or query device, not separately depicted) may utilize the query information received at “5” to interrogate a data store that relates a plurality of identifiers of beacon devices 406 to various discrete location-based information (e.g., as depicted in the data storage structure 340 of FIG. 3 herein) and identify matching data. The database 440b may then, for example, provide a query response (“RS”) to the server 410 at “7”. In some embodiments, the query response may include discrete location-based information related to and/or stored in relation to the beacon device 406, such as a location identifier, maps, floorplans, office diagrams, in-building food/beverage resources, bathroom locations, employee directories and/or information, etc. In some embodiments, the server 410 may forward or transmit the response received at “7” to the mobile electronic device 402 (and/or the application instructions 442 thereof) at “8”. The transmission at “8” may, for example, comprise a response (“RS”) to the provision of the data as input at “4”. In such a manner, for example, the mobile electronic device 402 may automatically receive/retrieve the location identifier from the registry (e.g., the database 440b).

In some embodiments, the application instructions 442 may utilize the information received at “8” to generate one or more interface/GUI components such as maps, images, forms, data fields, etc., at “9”. The application instructions 442 may display, via a transmission to the I/O device 414 at “10” for example, a GUI having at least one user-selectable object for selectively displaying the location-dependent information as described herein. In some embodiments, the application instructions 442 may wait to receive a user selection of the user-selectable object (or a subset of selectable objects). Upon receipt of a user selection by the I/O device 414, user input (e.g., selection information) may be transmitted back to the application instructions 442 as input at “11”. According to some embodiments, the application instructions 442 may automatically access the location-dependent information using the location identifier in response to the selection of a user-selectable object indicated by the information received at “11”. In some embodiments, the location-dependent information may be utilized to update the GUI and/or the location-dependent information itself may be displayed, via a return to “10”.

According to some embodiments, the input received from the user at “11” may be processed and/or utilized to cause or trigger a device activation, such as dimming or flashing a light or opening an electronic door lock/latch, as described herein. In some embodiments, the application instructions 442 may encode or encrypt the user input received at “11” and/or other user information, such as user security credentials, at “12”. The application instructions 442 may then, for example, forward or transmit the processed (e.g., encrypted, encoded, compressed, filtered) data as input to the server 410, at “13”. In some embodiments, such as in response to the receipt of the data at “13”, the server 410 may structure and/or initiate a query to the database 440b, at “14”. According to some embodiments, at “15” the database 440b (and/or a controlling device thereof, such as a database administration and/or query device) may utilize the query information received at “14” to interrogate a data store that relates security and/or other rules-based information to situational answers, actions, and/or decisions (e.g., as depicted in the data storage structure 340 of FIG. 3 herein) and identifies matching data. The database 440b may then, for example, provide a query response (“RS”) to the server 410 at “16”. In some embodiments, the query response may include an indication of data related to the input provided and/or a result from an application of a stored rule associated therewith. The query response may, for example, indicate that the user of the mobile electronic device 402 (and/or the mobile electronic device 402) is not authorized to access a particular area or actuate a particular object, or alternatively may provide a code, command, and/or transmission protocol that may be utilized to actuate the actuator 408 (e.g., in the case that security access has been verified or authenticated by comparing the user/device identifier(s) to stored data in the database 440b). In some embodiments, the server 410 may utilize the information from received at “16” to structure and/or send a command to the actuator 408, such as to modify an illumination level and/or color of a light, open or close a door latch, engage or disengage a security turnstile, activate or deactivate an elevator, etc., at “17”. In some embodiments, the command may also or alternately be provided via or by the mobile electronic device 402 (and/or the application instructions 442 and/or the processing unit 412 thereof). According to some embodiments, the actuator 408 may actuate to physically, magnetically, and/or electronically engage to impart movement to a physical object (not shown) and/or alter the output of one or more electronic output devices (e.g., lights, buzzers; also not separately shown), at “18”. In some embodiments, the actuator 408 may provide a status update to the server 410, at “19”. In such a manner, for example, the server 410 may be appraised of a current status of the actuator 408 and may incorporate such information into decision-making logic, such as deciding whether or not to open or close a door (e.g., a door that may already be open or closed, as indicated by the status received at “19”).

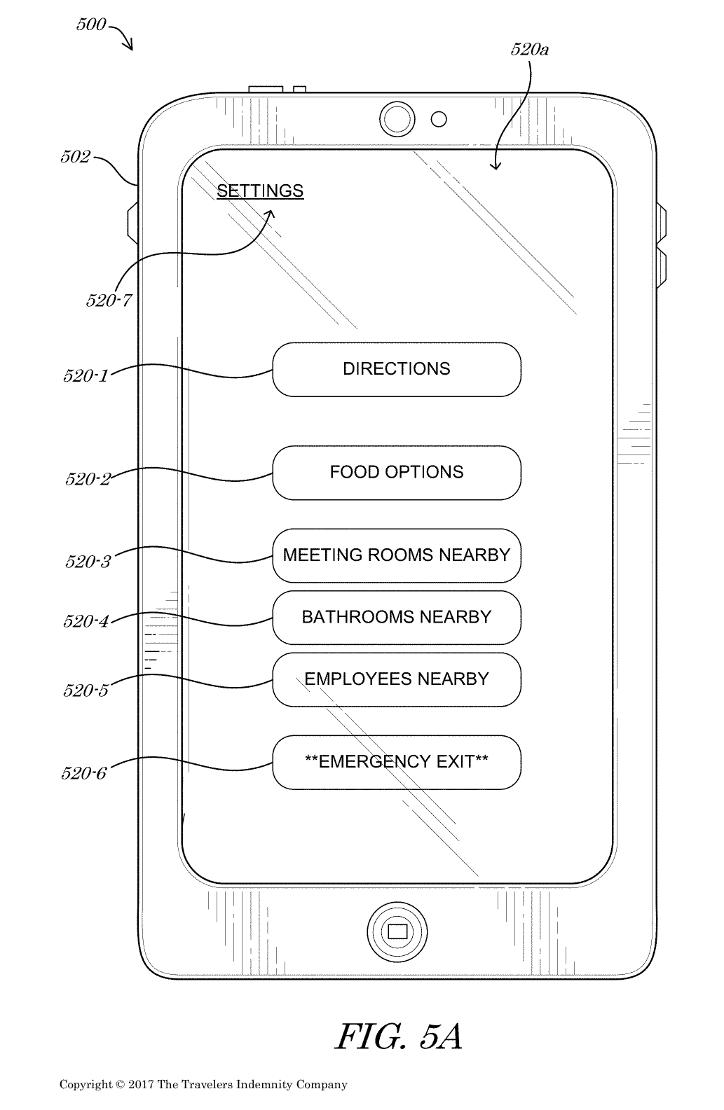

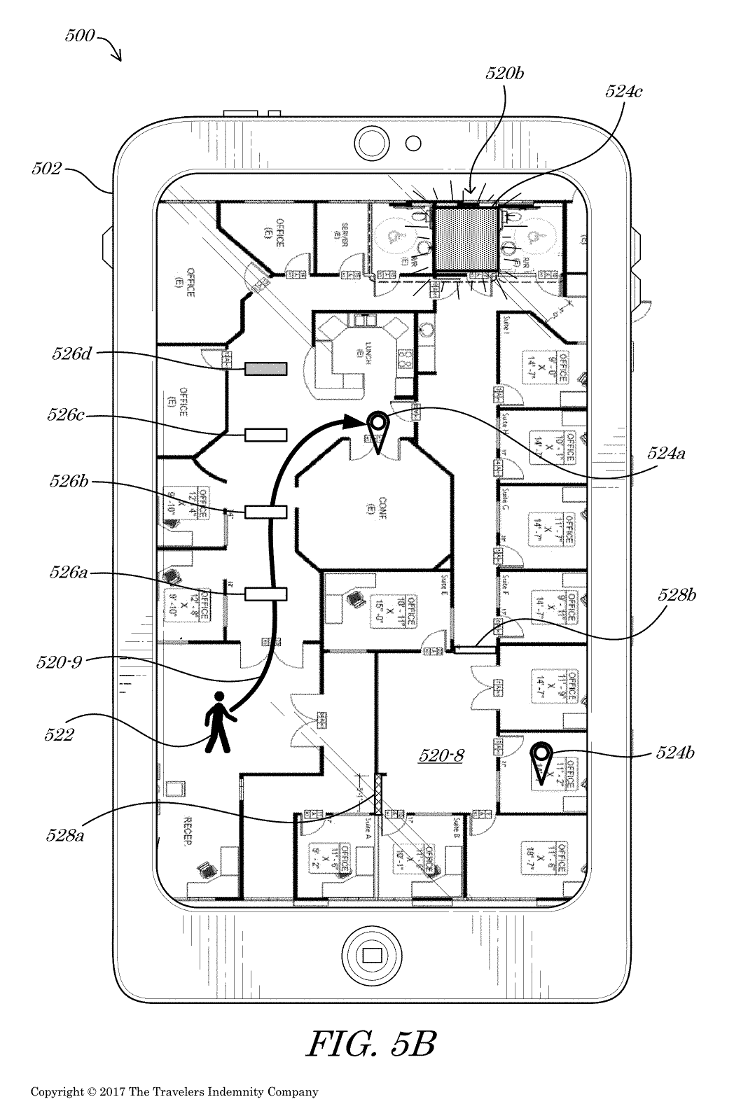

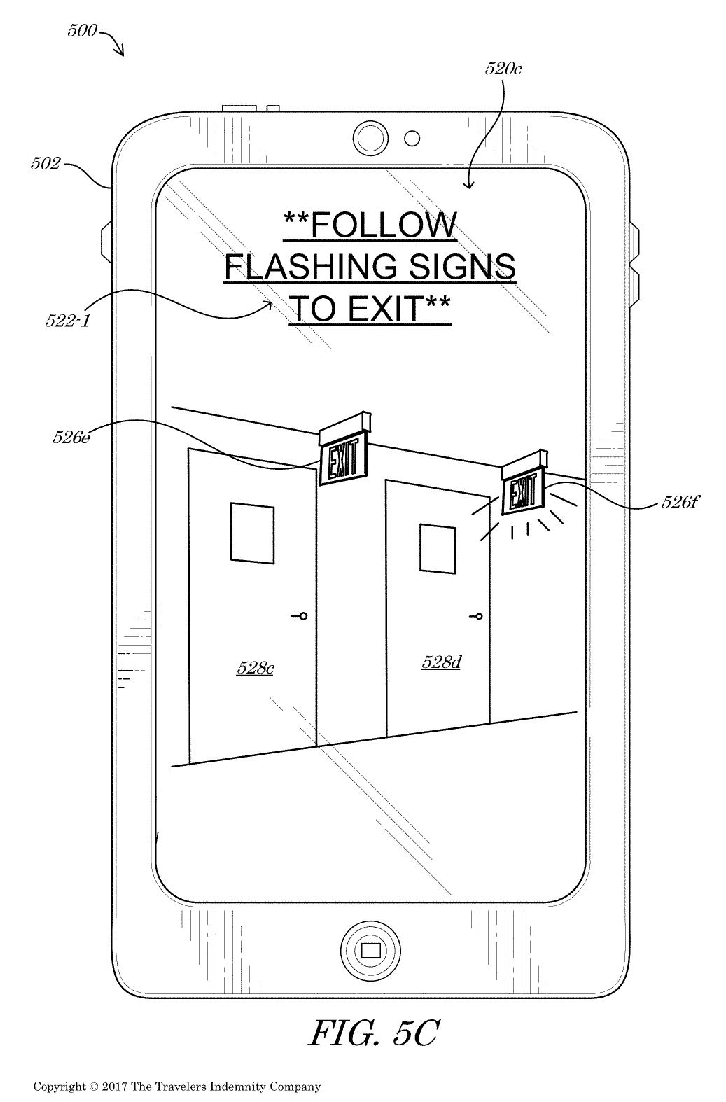

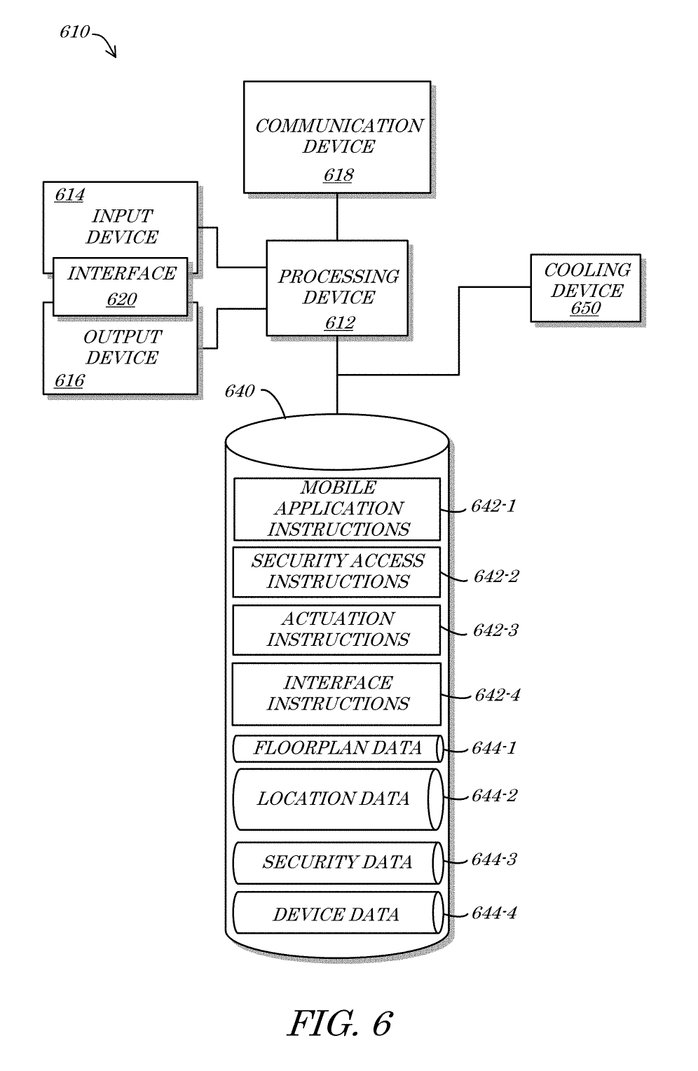

Turning now to FIG. 5A, FIG. 5B, and FIG. 5C, diagrams of a system 500 depicting a user device 502 providing instances of an example interface 520a-c according to some embodiments are shown. In some embodiments, the interface 520a-c may comprise a web page, web form, database entry form, API, spreadsheet, table, and/or application or other GUI via which a user or other entity may enter data (e.g., provide or define input) to enable receipt of discrete location-based information and/or trigger discrete location-based functionality, as described herein. The interface 520a-c may, for example, comprise a front-end of a hyper-local mobile application navigational program and/or platform programmed and/or otherwise configured to execute, conduct, and/or facilitate the systemic method 400 of FIG. 4 herein, and/or portions thereof. In some embodiments, the interface 520a-c may be output via a computerized device, such as the user device 502, which may for example, be similar in configuration to one or more of the user/mobile devices 102a-n, 202, 402 and/or the controller device 110, the server 210, 410, or the apparatus 610, of FIG. 1, FIG. 2, FIG. 4, and/or FIG. 6 herein.

According to some embodiments, the interface 520a-c may comprise one or more tabs and/or other segmented and/or logically-presented data forms and/or fields. In some embodiments, the interface 520a-c may be configured and/or organized to allow and/or facilitate entry of information regarding a desired or target location (e.g., a destination), a specific room, employee, department, object, feature, and/or actuatable device. According to some embodiments, the interface 502a-c may comprise a menu page from which a user may select one or more options that initiate specific functionality of the mobile device application. As depicted in FIG. 5A, for example, a first version (or page or instance) of the interface 520a may comprise a “Menu” or “Home Page” interface (e.g., defining a first input and/or output mechanism), such as by providing an area (e.g., one or more data entry mechanisms, tools, objects, and/or features) that provides for selection/activation of (i) a “directions” button 520-1, (ii) a “food options” button 520-2, (iii) a “meeting rooms nearby” button 520-3, (iv) a “bathrooms nearby” button 520-4, (v) an “employees nearby” button 520-5, (vi) an “emergency exit” button 520-6, and/or (vii) a “settings” link 520-7.

In some embodiments, the first version (or page or instance) of the interface 520a may be utilized to enable access to various hyper-local/discrete location-based information and/or functionality. The directions button 520-1 may, when actuated or selected by the user, for example, initiate a sub-routine that computes and outputs hyper-local directions to guide the user to a desired destination, e.g., on a campus, in a building, etc. Such a hyper-local directions functionality may, for example, utilize a derived and/or calculated current location (e.g., based on wireless beacon strength and known location) of the user device 502, a known location of the destination (e.g., defined by user input), and a known hyper-local map (e.g., a floorplan of a particular floor of a building), to calculate and output a navigational route. In some embodiments, the food options button 520-2 may, when actuated or selected by the user, for example, initiate a sub-routine that retrieves discrete location-based food/beverage information, such as locations of the nearest food/beverage facilities (e.g., restaurants, cafeterias, food trucks, vending machines, kitchen areas), menus, prices, etc. According to some embodiments, the meeting rooms nearby button 520-3, the bathrooms nearby button 520-4, and the employees nearby button 520-5 may, when actuated or selected by the user, for example, initiate sub-routines that utilize a current location of the user device 502 and known discrete locations of various meeting/conference rooms, bathrooms, employee workstations or offices, respectively, to inform the user (e.g., via output of the user device 502) of the most proximate instances of such facilities and/or information descriptive of those facilities or locations (e.g., a listing of bathroom amenities or types (e.g., whether accessible or not), conference room reservation and/or dial-in information, employee contact information, etc.).

In some embodiments, the emergency exit button 520-6 may, when actuated or selected by the user, for example, initiate a sub-routine that directs the user to the nearest or safest (e.g., not near an emergency event location) exit points and routes the user out of a building or to a safe location within (e.g., a safe room) a building. According to some embodiments, the settings link 520-7 may, when actuated or selected by the user, for example, initiate a sub-routine that enables the entry of various preference and/or settings information for the mobile application. The user may be prompted to enter or may be enabled to enter (e.g., via one or more data entry objects, such as a picklist—not shown in FIG. 5A) desired “favorite” locations (such as a friend's office location or a commonly-used meeting room), desired filter options (e.g., to set the application to never display vending machine information or to prioritize certain information such as Starbucks® locations), and/or applicable security information, such as a security identifier (e.g., badge or tag number), keycode, encryption key, etc.

In some embodiments, the application may cause the first interface 520a to display other or additional user-selectable menu choices (not shown) including meeting requestor posts, which represents posts from a person whom the user is scheduled to meet with that day, an employee directory that includes names, contact information, and location information displayed on one or more floor maps for employees, and a Café Menu that shows menu information for that day in the corporate cafeterias. The user-selectable menu choices displayed by the application may be part of a library of user-selectable objects. In some embodiments, the library of user-selectable objects includes other user-selectable objects that are selectively included for display based on their perceived relevance to a scheduled meeting and/or the user's location. For example, in some embodiments, the other user-selectable objects may include a calendar, a project management hierarchy, and additional employee information. In some embodiments, at least one user-selectable object for selectively displaying the location-dependent information includes a subset of a library of user-selectable objects selected at least in part based on the approximate distance between the user device 502 and one or more wireless transmitters (not shown in FIG. 5A). This enables the application to display, for example, maps having the appropriate features and/or scale at the appropriate times to help guide the user to the meeting/destination.

Referring to FIG. 5B, a second version (or page or instance) of the interface 520b may comprise a directions or hyper-local map interface (e.g., defining a second input and/or output mechanism) by providing a discrete location-based map or floorplan 520-8 with output of a route 520-9 from a current location of a user 522 to one or more desired or target destinations 524a-c. The second version (or page or instance) of the interface 520b may be utilized, for example, to view nearby locations of interest (and/or receive discrete navigational routing thereto) and may be provided in response to one or more inputs provided via different versions of the interface 520a, 520c. The directions button 520-1 of the first version of the interface 520a may, for example, upon a triggering and/or receipt of input from the user (e.g., a properly-positioned click of a mouse or other pointer) with respect to the directions button 520-1, trigger a call to and/or otherwise cause a provision, generation, and/or outputting of the second version of the interface 520b. In some embodiments, the second version (or page or instance) of the interface 520b may comprise a depiction of the current location of the user (and/or user's device) 522, as calculated or derived from information descriptive of a wireless beacon (not shown) e.g., in the same room as the user, that has provided a UUID to the mobile device of the user. According to some embodiments, the user may provide input indicating that a first desired destination 524a is a particular meeting room. In some embodiments, such information may be retrieved automatically from a calendar appointment of the user, such as by being automatically retrieved from a scheduling application or information store on the user's mobile device. In some embodiments, e.g. in response to a user selection of a particular conference room, the application may display a distance (not shown) to the selected conference room—e.g., the first location 524a. Upon arrival at the first location 524a, because the distance has reached a minimum threshold value, such as six (6) feet, for example, a message indicating “You are here!” may be displayed instead. The application may also display a label for the destination such as “Conference Room 1”. In some embodiments, the application may display an agenda (not shown) for the destination. In this example, “Conference Room 1” may be reserved from 9:00 AM through 10:00 AM for a new product planning meeting, from 1:00 PM through 2:30 PM for vendor presentations and from 3:00 PM to 5:00 PM for employee training. In such a manner, the user may not only be directed to the desired destination but also provided with hyper-local contextual information for the destination, such as what times activities pertaining to the user are scheduled.

In some embodiments, the discrete location-based directions/routing may comprise remote activation of one or more of a plurality of lights (bulbs, fixtures, etc.) 526a-d disposed along or near the route 520-9. Based on stored device information and related hyper-local location information, for example, actuatable devices, such as the lights 526a-d, within a predetermined distance of the route 520-9 and/or various points thereof (not separately depicted) may be selectively actuated. In the example floorplan 520-8 of FIG. 5B, for example, the first three (3) lights 526a-c may be remotely actuated to indicate the desired route 520-9 to the user. The first three (3) lights 526a-c may, for example, be illuminated, turned-off, caused to blink, set at a particular illumination level (e.g., dimmed), caused to illuminate in a specific color (e.g., in the case of color-changing LED lights), and/or in the case of multiple bulbs/diodes in each light 526a-c, may be selectively illuminated—e.g., the middle bulbs in the first two (2) lights 526a-b may be blinked, while the right-most bulbs in the third light 526c may be blinked, denoting that the route 520-9 turns to the right. In some embodiments, a fourth light 526d may be turned off, not altered, or illuminated in red, for example, to denote that the route 520-9 does not proceed past the fourth light 526d. In such a manner, for example, the lights 526a-d (and/or other remotely actuatable devices as described herein) may be utilized to provide a dynamic, electronic “trail marker” system that facilitates the guiding of the user along the route 520-9.

According to some embodiments, the meeting rooms nearby button 520-3, the bathrooms nearby button 520-4, and/or the employees nearby button 520-5 of the first version of the interface 520a may, for example, upon a triggering and/or receipt of input from the user (e.g., a properly-positioned click of a mouse or other pointer) with respect to the respective button(s) 520-2, 520-3, 520-4, trigger a call to and/or otherwise cause a provision, generation, and/or outputting of the second version of the interface 520b. In some embodiments, the second version (or page or instance) of the interface 520b may comprise a depiction of a second location 542b, such as a graphical marker showing a location of a specific employee's office and/or a third location 524c, such as a location of a restroom facility. According to some embodiments, a plurality of actuatable entry devices 528a-b may be associated with the second location 524b. In some embodiments, security clearance and/or setting information may be utilized to guide the user to the second location 524b and/or to facilitate access of the second location 524b by the user.

In the case that a first one of the actuatable entry devices 528a comprises a restricted-access security door (or perhaps an emergency-only door), for example, while the shortest route to the second location 524b would typically be directly from the current location of the user 522 and through the first actuatable entry device 528a, the route 520-9 (or a portion thereof) may instead be output to route the user around the inaccessible first actuatable entry device 528a. According to some embodiments, a second actuatable entry device 528b, based on a comparison of the user's security information and security access rules or information for the second actuatable entry device 528b, for example, may be automatically activated, engaged, disengaged, and/or otherwise commanded to enable the user to pass through to the second location 524b.

Turning to FIG. 5C, a third version (or page or instance) of the interface 520c may comprise an emergency exit interface (e.g., defining a third input and/or output mechanism) by providing emergency exit instructions 522-1 and/or visual (or other output) navigational cues, such as selectively illuminated exit signs 526e-f associated with respective exit doors 528c-d. The third version (or page or instance) of the interface 520c may be utilized, for example, to guide a user to a safe location (e.g., utilizing information from nearby wireless beacons—not shown) and may be provided in response to one or more inputs provided via different versions of the interface 520a-b. The emergency exit button 520-6 of the first version of the interface 520a may, for example, upon a triggering and/or receipt of input from the user (e.g., a properly-positioned click of a mouse or other pointer) with respect to the emergency exit button 520-6, trigger a call to and/or otherwise cause a provision, generation, and/or outputting of the third version of the interface 520c. In some embodiments, the third version (or page or instance) of the interface 520c may display an image of a location at which the user is determined to be located, based on hyper-local location information derived from wireless beacon data acquired by the user device 502. In some embodiments, the display may be configured to facilitate the user's understanding of the suggested route (e.g., the route 520-9) by familiarizing the user with their surroundings. The emergency exit instructions 522-1 may also or alternatively guide the user by providing route and/or exit instructions. According to some embodiments, such as in the example depicted in FIG. 5C, the emergency exit instructions 522-1 may direct the user to watch for flashing signs (and/or lights) that are automatically actuated along the suggested route, such as the illuminated/blinking exit sign 526f in FIG. 5C. In some embodiments, the respective exit door 528d may be automatically unlocked or opened to facilitate the user's exit. In some embodiments, the incorrect or undesirable exit door 528c may be automatically locked and/or the respective exit sign 526e may be turned off to prevent the user from getting lost or going off-route. In some embodiments, the third version (or page or instance) of the interface 520c may comprise an augmented reality display that shows a real-time image of the user's surroundings (e.g., captured by an imaging device (not depicted) of the user device 502) augmented with a virtual flashing or illumination of the desired exit sign 526f and/or the respective exit door 528d. In such a manner, for example, the actual exit lights 526e-f need not be actuated but may appear to be actuated by graphical representations on the GUI overlaid on a real-time image/video of the user's surroundings. Such an embodiment may be advantageous in the case that the exit lights 526e-f are of a legacy type that does not permit remote actuation or control (e.g., for older buildings).

While various components of the interface 520a-c have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Turning to FIG. 6, a block diagram of an apparatus 610 according to some embodiments is shown. In some embodiments, the apparatus 610 may be similar in configuration and/or functionality to any of the controller device 110, the server 210, 410, and/or the user/mobile devices 102a-n, 202, 402 of FIG. 1, FIG. 2, and/or FIG. 4 herein. The apparatus 610 may, for example, execute, process, facilitate, and/or otherwise be associated with the systemic method 400 of FIG. 4 herein, and/or portions thereof. In some embodiments, the apparatus 610 may comprise a processing device 612, an input device 614, an output device 616, a communication device 618, an interface 620, a memory device 640 (storing various programs and/or instructions 642 and data 644), and/or a cooling device 650. According to some embodiments, any or all of the components 612, 614, 616, 618, 620, 640, 642, 644, 650 of the apparatus 610 may be similar in configuration and/or functionality to any similarly named and/or numbered components described herein. Fewer or more components 612, 614, 616, 618, 620, 640, 642, 644, 650 and/or various configurations of the components 612, 614, 616, 618, 620, 640, 642, 644, 650 be included in the apparatus 610 without deviating from the scope of embodiments described herein.

According to some embodiments, the processor 612 may be or include any type, quantity, and/or configuration of processor that is or becomes known. The processor 612 may comprise, for example, an Intel® IXP 2800 network processor or an Intel® XEON™ Processor coupled with an Intel® E7501 chipset. In some embodiments, the processor 612 may comprise multiple inter-connected processors, microprocessors, and/or micro-engines. According to some embodiments, the processor 612 (and/or the apparatus 610 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 610 comprises a server such as a blade server, necessary power may be supplied via a standard AC outlet, power strip, surge protector, and/or Uninterruptible Power Supply (UPS) device.

In some embodiments, the input device 614 and/or the output device 616 are communicatively coupled to the processor 612 (e.g., via wired and/or wireless connections and/or pathways) and they may generally comprise any types or configurations of input and output components and/or devices that are or become known, respectively. The input device 614 may comprise, for example, a keyboard that allows an operator of the apparatus 610 to interface with the apparatus 610 (e.g., by an administrator, such as to define hyper location-based information relationships, as described herein). In some embodiments, the input device 614 may comprise a sensor such as a receiver configured to provide information such as wireless beacon identifiers, to the apparatus 610 and/or the processor 612. The output device 616 may, according to some embodiments, comprise a display screen and/or other practicable output component and/or device. The output device 616 may, for example, provide an interface (such as the interface 620 and/or the interface 520a-c of FIG. 5A, FIG. 5B, and/or FIG. 5C herein) via which discrete location-based information and/or functionality are provided to a user (e.g., via a website and/or mobile application). According to some embodiments, the input device 614 and/or the output device 616 may comprise and/or be embodied in a single device such as a touch-screen monitor.

In some embodiments, the communication device 618 may comprise any type or configuration of communication device that is or becomes known or practicable. The communication device 618 may, for example, comprise a Network Interface Card (NIC), a telephonic device, a cellular network device, a router, a hub, a modem, and/or a communications port or cable. In some embodiments, the communication device 618 may be coupled to receive UUID data from a wireless beacon device, such as in the case that the apparatus 610 is utilized to acquire beacon information and utilize the information to retrieve and/or generate hyper-local location-based information and/or functionality. The communication device 618 may, for example, comprise a BLE and/or RF receiver device that acquires wireless beacon broadcast UUID data and/or a transmitter device that provides the data to a remote server. According to some embodiments, the communication device 618 may also or alternatively be coupled to the processor 612. In some embodiments, the communication device 618 may comprise an IR, RF, Bluetooth™, Near-Field Communication (NFC), and/or Wi-Fi® network device coupled to facilitate communications between the processor 612 and another device (such as a wireless beacon device, not shown in FIG. 6).

The memory device 640 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 640 may, according to some embodiments, store one or more of mobile application instructions 642-1, security access instructions 642-2, actuation instructions 642-3, interface instructions 642-4, floorplan data 644-1, location data 644-2, security data 644-3, and/or device data 644-4. In some embodiments, the mobile application instructions 642-1, security access instructions 642-2, actuation instructions 642-3, interface instructions 642-4 may be utilized by the processor 612 to provide output information via the output device 616 and/or the communication device 618.

According to some embodiments, the mobile application instructions 642-1 may be operable to cause the processor 612 to process the floorplan data 644-1, location data 644-2, security data 644-3, and/or device data 644-4 in accordance with embodiments as described herein. Floorplan data 644-1, location data 644-2, security data 644-3, and/or device data 644-4 received via the input device 614 and/or the communication device 618 may, for example, be analyzed, sorted, filtered, decoded, decompressed, ranked, scored, plotted, and/or otherwise processed by the processor 612 in accordance with the mobile application instructions 642-1. In some embodiments, floorplan data 644-1, location data 644-2, security data 644-3, and/or device data 644-4 may be fed by the processor 612 through one or more mathematical and/or statistical formulas and/or models in accordance with the mobile application instructions 642-1 to provide mobile device functionality, such as utilizing beacon data to access discrete location-based data, receive hyper-local directions, and/or cause or trigger one or more actuatable devices, as described herein.

In some embodiments, the security access instructions 642-2 may be operable to cause the processor 612 to process the floorplan data 644-1, location data 644-2, security data 644-3, and/or device data 644-4 in accordance with embodiments as described herein. Floorplan data 644-1, location data 644-2, security data 644-3, and/or device data 644-4 received via the input device 614 and/or the communication device 618 may, for example, be analyzed, sorted, filtered, decoded, decompressed, ranked, scored, plotted, and/or otherwise processed by the processor 612 in accordance with the security access instructions 642-2. In some embodiments, floorplan data 644-1, location data 644-2, security data 644-3, and/or device data 644-4 may be fed by the processor 612 through one or more mathematical and/or statistical formulas and/or models in accordance with the security access instructions 642-2 to determine, verify, and/or authenticate user access to a particular location and/or device and in the case that access is verified, remotely actuate the device for the user, as described herein.

According to some embodiments, the actuation instructions 642-3 may be operable to cause the processor 612 to process the floorplan data 644-1, location data 644-2, security data 644-3, and/or device data 644-4 in accordance with embodiments as described herein. Floorplan data 644-1, location data 644-2, security data 644-3, and/or device data 644-4 received via the input device 614 and/or the communication device 618 may, for example, be analyzed, sorted, filtered, decoded, decompressed, ranked, scored, plotted, and/or otherwise processed by the processor 612 in accordance with the actuation instructions 642-3. In some embodiments, floorplan data 644-1, location data 644-2, security data 644-3, and/or device data 644-4 may be fed by the processor 612 through one or more mathematical and/or statistical formulas and/or models in accordance with the actuation instructions 642-3 to identify remote actuatable device associated with user locations/routes, identify actuation protocols and/or codes, and remotely command the devices in accordance with predefined rules, as described herein.

In some embodiments, the interface instructions 642-4 may be operable to cause the processor 612 to process the floorplan data 644-1, location data 644-2, security data 644-3, and/or device data 644-4 in accordance with embodiments as described herein. Floorplan data 644-1, location data 644-2, security data 644-3, and/or device data 644-4 received via the input device 614 and/or the communication device 618 may, for example, be analyzed, sorted, filtered, decoded, decompressed, ranked, scored, plotted, and/or otherwise processed by the processor 612 in accordance with the interface instructions 642-4. In some embodiments, floorplan data 644-1, location data 644-2, security data 644-3, and/or device data 644-4 may be fed by the processor 612 through one or more mathematical and/or statistical formulas and/or models in accordance with the interface instructions 642-4 to provide an interface (such as the interface 620 and/or the interface 520a-c of FIG. 5A, FIG. 5B, and/or FIG. 5C herein) via which input and/or output descriptive of discrete location-based information and/or functionality may be provided, as described herein.

According to some embodiments, the apparatus 610 may comprise the cooling device 650. According to some embodiments, the cooling device 650 may be coupled (physically, thermally, and/or electrically) to the processor 612 and/or to the memory device 640. The cooling device 650 may, for example, comprise a fan, heat sink, heat pipe, radiator, cold plate, and/or other cooling component or device or combinations thereof, configured to remove heat from portions or components of the apparatus 610.

Any or all of the exemplary instructions and data types described herein and other practicable types of data may be stored in any number, type, and/or configuration of memory devices that is or becomes known. The memory device 640 may, for example, comprise one or more data tables or files, databases, table spaces, registers, and/or other storage structures. In some embodiments, multiple databases and/or storage structures (and/or multiple memory devices 640) may be utilized to store information associated with the apparatus 610. According to some embodiments, the memory device 640 may be incorporated into and/or otherwise coupled to the apparatus 610 (e.g., as shown) or may simply be accessible to the apparatus 610 (e.g., externally located and/or situated).

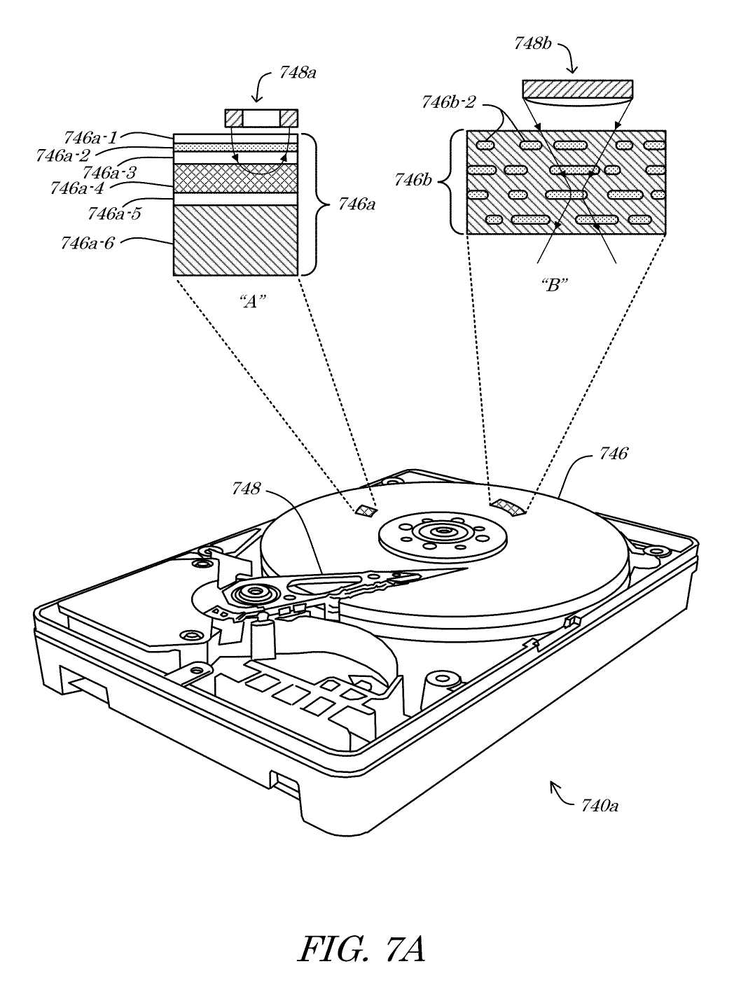

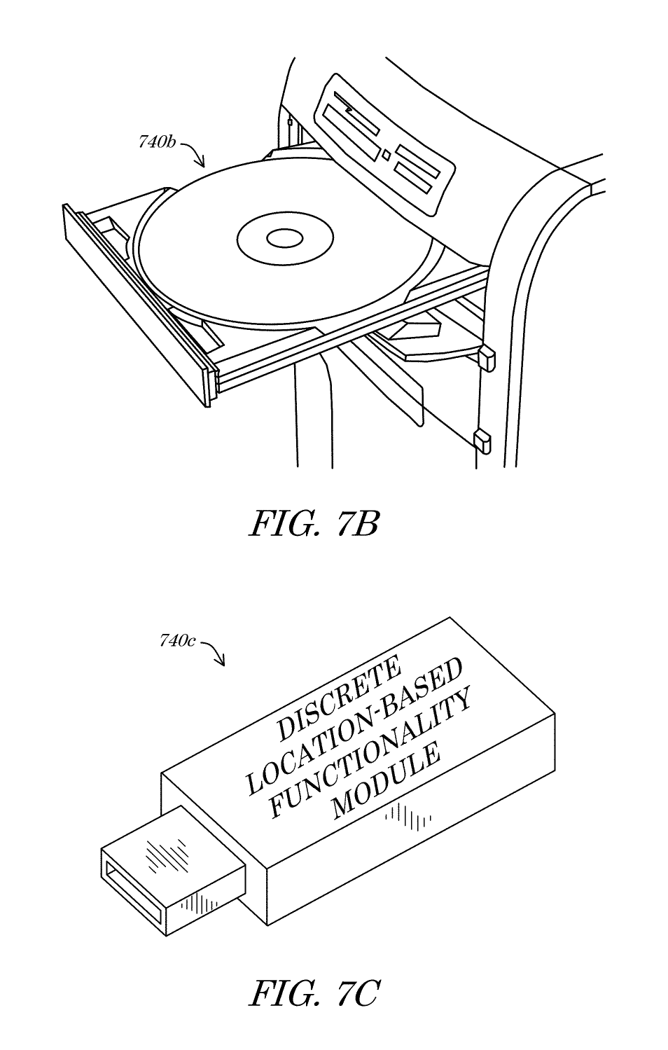

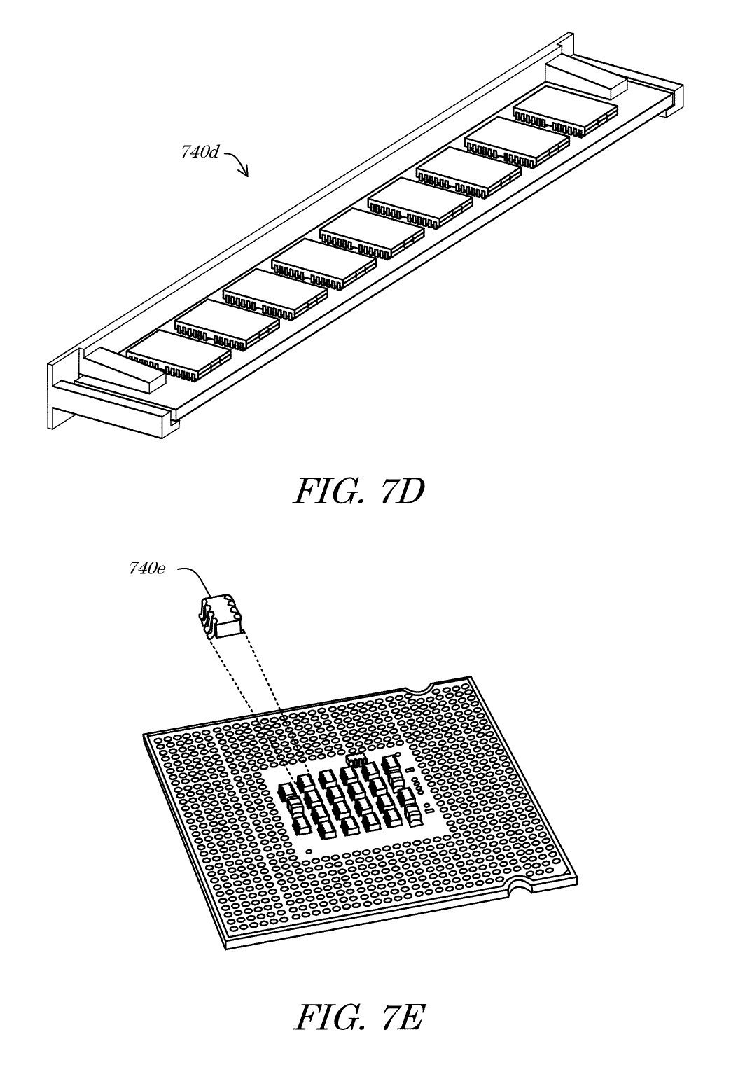

Referring to FIG. 7A, FIG. 7B, FIG. 7C, FIG. 7D, and FIG. 7E, perspective diagrams of exemplary data storage devices 740a-e according to some embodiments are shown. The data storage devices 740a-e may, for example, be utilized to store instructions and/or data such as the mobile application instructions 642-1, security access instructions 642-2, actuation instructions 642-3, interface instructions 642-4, floorplan data 644-1, location data 644-2, security data 644-3, and/or device data 644-4, each of which is presented in reference to FIG. 6 herein. In some embodiments, instructions stored on the data storage devices 740a-e may, when executed by a processor, cause the implementation of and/or facilitate the systemic method 400 of FIG. 4 herein, and/or portions thereof.

According to some embodiments, the first data storage device 740a may comprise one or more various types of internal and/or external hard drives. The first data storage device 740a may, for example, comprise a data storage medium 746 that is read, interrogated, and/or otherwise communicatively coupled to and/or via a disk reading device 748. In some embodiments, the first data storage device 740a and/or the data storage medium 746 may be configured to store information utilizing one or more magnetic, inductive, and/or optical means (e.g., magnetic, inductive, and/or optical-encoding). The data storage medium 746, depicted as a first data storage medium 746a for example (e.g., breakout cross-section “A”), may comprise one or more of a polymer layer 746a-1, a magnetic data storage layer 746a-2, a non-magnetic layer 746a-3, a magnetic base layer 746a-4, a contact layer 746a-5, and/or a substrate layer 746a-6. According to some embodiments, a magnetic read head 748a may be coupled and/or disposed to read data from the magnetic data storage layer 746a-2.

In some embodiments, the data storage medium 746, depicted as a second data storage medium 746b for example (e.g., breakout cross-section “B”), may comprise a plurality of data points 746b-2 disposed with the second data storage medium 746b. The data points 746b-2 may, in some embodiments, be read and/or otherwise interfaced with via a laser-enabled read head 748b disposed and/or coupled to direct a laser beam through the second data storage medium 746b.

In some embodiments, the second data storage device 740b may comprise a CD, CD-ROM, DVD, Blu-Ray™ Disc, and/or other type of optically-encoded disk and/or other storage medium that is or becomes know or practicable. In some embodiments, the third data storage device 740c may comprise a USB keyfob, dongle, and/or other type of flash memory data storage device that is or becomes know or practicable. In some embodiments, the fourth data storage device 740d may comprise RAM of any type, quantity, and/or configuration that is or becomes practicable and/or desirable. In some embodiments, the fourth data storage device 740d may comprise an off-chip cache such as a Level 2 (L2) cache memory device. According to some embodiments, the fifth data storage device 740e may comprise an on-chip memory device such as a Level 1 (L1) cache memory device.

The data storage devices 740a-e may generally store program instructions, code, and/or modules that, when executed by a processing device cause a particular machine to function in accordance with one or more embodiments described herein. The data storage devices 740a-e depicted in FIG. 7A, FIG. 7B, FIG. 7C, FIG. 7D, and FIG. 7E are representative of a class and/or subset of computer-readable media that are defined herein as “computer-readable memory” (e.g., non-transitory memory devices as opposed to transmission devices or media).

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

Some embodiments herein describe a wireless system for delivering location-dependent information to a portable computing device. The wireless system may include at least one wireless transmitter adapted to transmit a unique transmitter identifier and a registry linking the unique transmitter identifier to a location identifier, the registry having memory for storing the transmitter identifier and the location identifier. The wireless system may also include a software application executing on the portable computing device, the software application adapted to automatically receive the transmitter identifier from the at least one wireless transmitter, access the registry memory using the transmitter identifier, receive the location identifier from the registry, and access the location-dependent information using the location identifier, the software application having a GUI displaying at least one user-selectable object for selectively displaying the location-dependent information.

Other embodiments herein describe a method for delivering location-dependent information to a portable computing device. The method may include transmitting a unique transmitter identifier from at least one wireless transmitter, linking the unique transmitter identifier to a location identifier with a registry, the registry having memory for storing the transmitter identifier and the location identifier, and automatically receiving the transmitter identifier from the at least one wireless transmitter. The method may also include automatically accessing the registry memory using the transmitter identifier, automatically receiving the location identifier from the registry, and displaying a GUI having at least one user-selectable object for selectively displaying the location-dependent information. The method may further include automatically accessing the location-dependent information using the location identifier in response to selection of a user-selectable object and displaying the location-dependent information.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

1. A wireless system for delivering location-dependent information to a portable computing device, comprising:
at least one wireless transmitter adapted to transmit a unique transmitter identifier;
a registry linking the unique transmitter identifier to a location identifier, the registry having memory for storing the transmitter identifier and the location identifier;
a software application executing on the portable computing device, the software application adapted to automatically receive the transmitter identifier from the at least one wireless transmitter, access the registry memory using the transmitter identifier, receive the location identifier from the registry, access the location-dependent information using the location identifier, and selectively transmit based on the location-dependent information, a signal to an actuatable device, thereby causing an actuation of the actuatable device, and the software application having a graphical user interface (GUI) displaying at least one user-selectable object for selectively displaying the location-dependent information.

2. The wireless system of claim 1, wherein the location-dependent information includes at least one of a map showing a location of an office, a map showing a location of a conference room, a map showing a location of a restroom, a self-guided multi-media tour guide, a local employee directory, a cafeteria menu, an emergency exit location, and a muster point for evacuation.

3. The wireless system of claim 1, wherein the registry is web-based.

4. The wireless system of claim 3, wherein the location-dependent information is accessed through a web-based cloud software application.

5. The wireless system of claim 1, wherein the location-dependent information is web-based.

6. The wireless system of claim 1, wherein the at least one wireless transmitter comprises a Bluetooth-compatible transmitter.

7. The wireless system of claim 1, wherein the at least one wireless transmitter comprises a WiFi beacon.

8. The wireless system of claim 1, wherein the portable computing device comprises a smart phone.

9. The wireless system of claim 1, wherein the location identifier identifies a portion of a floor in a building.

10. The wireless system of claim 1, wherein the at least one wireless transmitter further transmits an error detection code with the unique transmitter identifier.

11. The wireless system of claim 1, wherein the software application includes access to an application program interface (API).

12. The wireless system of claim 1, wherein the actuatable device comprises a door, and the actuation of the door causes the door to become unlocked for a limited period of time.

13. The wireless system of claim 1, wherein the software application measures signal strength from the at least one wireless transmitter to derive an approximate distance between the portable computing device and the at least one wireless transmitter.

14. The wireless system of claim 13, wherein the software application derives the approximate distance between the portable computing device and the at least one wireless transmitter by comparing the measured signal strength against an absolute signal strength.

15. The wireless system of claim 13, wherein the software application derives the approximate distance between the portable computing device and the at least one wireless transmitter by comparing the measured signal strength against a lookup table including a set of signal strengths and a corresponding set of approximate distances.

16. The wireless system of claim 13, wherein the at least one user-selectable object for selectively displaying the location-dependent information comprises a subset of a library of user-selectable objects selected at least in part based on the approximate distance between the portable computing device and the at least one wireless transmitter.

17. The wireless system of claim 13, wherein the location-dependent information is selected at least in part based on the approximate distance between the portable computing device and the at least one wireless transmitter.

18. A method for delivering location-dependent information to a portable computing device via a hyper-local map interface, comprising:
transmitting a unique transmitter identifier from at least one wireless transmitter;
linking the unique transmitter identifier to a location identifier with a registry, the registry having memory for storing the transmitter identifier and the location identifier;
automatically receiving the transmitter identifier from the at least one wireless transmitter;
automatically accessing the registry memory using the transmitter identifier;
automatically receiving the location identifier from the registry;
displaying a graphical user interface (GUI) having at least one user-selectable object for selectively displaying the location-dependent information;
automatically accessing the location-dependent information using the location identifier in response to a selection of a first one of the least one user-selectable objects;
displaying the location-dependent information;
identifying, based on the location-dependent information and a desired destination, discrete location-based directions from a current location of the portable computing device to a location of the desired destination;
identifying, along a route defined by the discrete location-based directions, at least one actuatable device; and
transmitting, to the at least one actuatable device, an actuation command.

19. The method of claim 18, wherein the at least one actuatable device comprises at least one electronically-actuatable door.

20. The method of claim 18, wherein the at least one actuatable device comprises a plurality of lights actuated in coordination to visually depict at least a portion of the route defined by the discrete location-based directions.
